(19) United States
(12) Patent Application Publication
(10) Pub. No.: US 2005/0076236 A1
(43) Pub. Date: Apr. 7, 2005

(54) Method and system for responding to network intrusions

(76) Inventor: Bryan Stephenson, Alviso, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/678,333

(22) Filed: Oct. 3, 2003

(51) Int. Cl. G06F 11/30

(52) U.S. Cl. 713/201

(57) ABSTRACT

A method and system for responding to network intrusions. Specifically, in one embodiment, the method begins by receiving an intrusion detection system (IDS) alert from an IDS sensor located in a network of computing resources. The IDS alert indicates an unauthorized intrusion upon a remotely located computing resource in the network of computing resources. The embodiment of the method continues by identifying the IDS alert. Then, the embodiment continues by determining an appropriate response to the IDS alert that is identified at a location separate from the remotely located computing resource so that the appropriate response is unaffected by the unauthorized intrusion. The embodiment of the method automatically implements the appropriate response to mitigate damage to the network of computing resources from the unauthorized intrusion.

### TECHNICAL FIELD

The various embodiments of the present invention relate to data centers of computing resources. More specifically, various embodiments of the present invention relate to the containment of intrusions in a data center of computing resources.

### BACKGROUND ART

Modern networking continues to provide an improvement in communication and information access. As an example, in-house data centers, associated with a particular entity or interrelated group of users, could contain a large number of information technology (IT) resources that are interconnected through a network. The resources in the in-house data centers are traditionally managed by network administrators.

These IT resources are exposed to possible security lapse and attacks through the communication links within the data center. Attacks can occur from hackers located outside the network associated with the data center who are trying to surreptitiously access and/or manipulate information within specific IT resources of the data center. Even more problematic is the unauthorized removal and manipulation of information by malicious persons who are generally given authorized access to the data within the data center, such as, disgruntled employees or contractors.

For example, in addition to the normal hacker attack, security breaches can consist of such things as the unauthorized entry into a portion of a database by an otherwise authorized user or the unauthorized use of an application managed by the data center. For instance, the use of a foreign engineering entity of a supercomputer computational fluid dynamics facility, perhaps barred by technology exchange law, wherein the foreign entity's use of other portions of the same data center is legitimate and desirable.

Intrusion detection systems (IDS) provide alerts when a breach of security has occurred to applications and operating systems of IT resources within a data center. Intrusion detection systems complement a network's or data center's security policies and systems. In a sense, thinking along traditional security systems, intrusion detection provides the video surveillance and burglar alarm systems that are set off when a building's security is compromised and valuable assets are being carted off. As such, intrusion detection systems provide alerts when the major threat has breached security systems and is lurking within the network and data center without authorization.

In general, two responses are implemented in response to an intrusion detection alert. One response is to is power down the infected IT resource. In that way, further intrusions into the IT resource are prevented, and damage to the IT resource is minimized. Another response is to disconnect the IT resource from the network. This prevents infection and damage to other IT resources in the network, or data center.

In conventional data centers, responses to intrusion detection alerts require the participation of a network administrator, or other human operator. The network administrator physically walks to the IT resource to power down the system or disconnect the IT resource from the network, or data center. Or, the network administrator might remotely access and use a tool which powers down the system or disconnects the IT resource from the network. As such, the response time may not occur quickly enough before damage has been done to the IT resource or the data center. For example, this problem may occur when the network administrator is overloaded with multiple alerts, or may be taking a break. Precious minutes may pass before the network administrator can appropriately address the intrusion detection alert, by which time, the damage may have been done.

In addition, conventional systems provide solutions to mitigating damage after a successful attack or intrusion that are generally limited to what can be done from within the system or IT resource itself. This is problematic since the solution is implemented and resides within the attacked IT resource. The attack or intrusion may deleteriously affect the response necessary to mitigate damage from the unauthorized intrusion. For example, the solution may put an attacked process into isolation from the IT resource, or terminate the process from within the IT resource.

Also, some host-based intrusion detection system (HIDS) software run scripts on a system to perform automatic responses to certain IDS alerts. The problem with this approach is that these scripts are running on the compromised IT resource, and thus are subject to interception or disablement from the malicious software, or intrusion. Another problem is that these scripts are limited in their capability. That is, the scripts are incapable of removing power to the IT resource, or to reconfigure the IT resource within the network. For example, the HIDS software may be configured to run the system shutdown script when an intrusion (e.g., malicious worm) is detected on the IT resource causing damage. However, the malicious worm may replace the system shutdown script and otherwise disable the HIDS in order to prevent the HIDS from performing any activity which would trigger an IDS response, thus rendering the automatic responses of the HIDS system ineffective. As a result, the intrusion can access the entire system with impunity.

For these and other reasons, a method and/or system that can reduce the time to respond to intrusion detection alerts, and initiate corrective or protective action from a system other than the affected IT resource or system would be of value. Embodiments of the present invention provide these and other advantages.

### DISCLOSURE OF THE INVENTION

A method and system for responding to network intrusions. Specifically, in one embodiment, the method begins by receiving an intrusion detection system (IDS) alert from an IDS sensor located in a network of computing resources. The IDS alert indicates an unauthorized intrusion upon a remotely located computing resource in the network of computing resources. The embodiment of the method continues by identifying the IDS alert. Then, the embodiment continues by determining an appropriate response to the IDS alert that is identified at a location separate from the remotely located computing resource so that the appropriate response is unaffected by the unauthorized intrusion. The embodiment of the method automatically implements the appropriate response to mitigate damage to the network of computing resources from the unauthorized intrusion.

### BRIEF DESCRIPTION OF THE DRAWINGS

The above and other objects and advantages of the present invention will be more readily appreciated from the following detailed description when read in conjunction with the accompanying drawings, wherein:

FIG. 1 is a block diagram illustrating a network system including a data center that is capable of responding to intrusion detection system (IDS) alerts in a data center, in accordance with one embodiment of the present invention.

FIG. 2 is a block diagram of switches within an exemplary local area network (LAN) that configure virtual local area networks (VLANs) upon which embodiments of the present invention can be implemented.

FIG. 3 is a block diagram illustrating a configuration of power cables for supplying power to a network of computing resources.

FIG. 4 is a flow chart illustrating steps in a computer implemented method for responding to IDS alerts in a data center, in accordance with one embodiment of the present invention.

FIG. 5 is a flow chart illustrating steps in a computer implemented method for detecting IDS alerts and responding to the IDS alerts in a data center, in accordance with one embodiment of the present invention.

### BEST MODES FOR CARRYING OUT THE INVENTION

Reference will now be made in detail to embodiments of the present invention, a method and system for responding to intrusion detection system (IDS) alerts in a data center, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments of the present invention can be implemented on software running on a computer system. The computer system can be a personal computer, notebook computer, server computer, mainframe, networked computer, handheld computer, personal digital assistant, workstation, and the like. In one embodiment, the computer system includes a processor coupled to a bus and memory storage coupled to the bus. The memory storage can be volatile or non-volatile and can include removable storage media. The computer can also include a display, provision for data input and output, etc.

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving,” or “identifying,” or “determining,” or “responding,” or “interfacing,” or “shutting down,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Accordingly, embodiments of the present invention provide a method and system for responding to IDS alerts in a data center. As a result, other embodiments of the present invention serve the above purpose and provide for automatic responses to IDS alerts, resulting in a reduction in damage to the data center from intrusion due to reduced response times. Also, other embodiments of the present invention serve the above purposes and provide for the elimination of human intervention when responding to an IDS alert, thereby decreasing the response time and reducing the resulting damage to the data center from unauthorized intrusion. Additionally, other embodiments of the present invention serve the above purposes and provide for the removal of the software responsible for responding to IDS alerts to a location separate from the computing resource upon which the intrusion is detected. As a result, a separate system for responding to the IDS alerts that has not been compromised through the intrusion is capable of responding appropriately to the intrusion as detected from the IDS alerts.

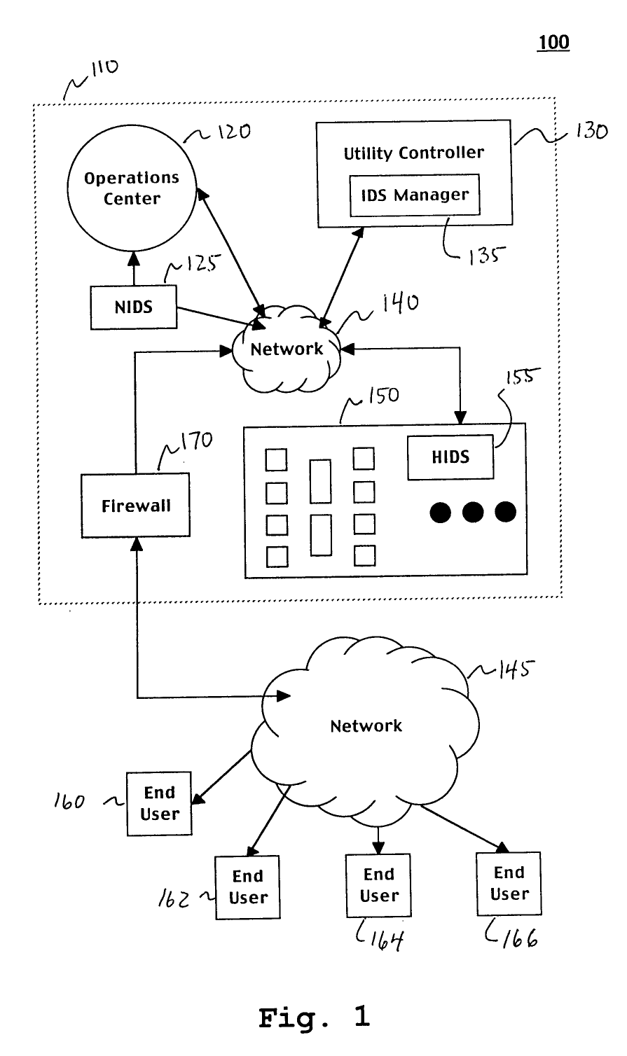

Referring now to FIG. 1, a block diagram of a networked system 100 illustrates the functionality of a utility data center (UDC) 110 (otherwise known as a provisional data center) with a plurality of end users, in accordance with one embodiment of the present invention. System 100 is comprised of the UDC 110 which is coupled through a network 145, such as, a virtual private network (VPN) or the Internet, to a plurality of end users (e.g., end users 160, 162, 164, 166, etc.) through the network 145. The UDC 110 is capable of responding appropriately to IDS alerts.

The UDC 110 of FIG. 1 is comprised of an operations center 120 that is coupled through a network 140 (e.g., a local area network) to a utility controller 130, and a pool 150 of computing resources. The UDC 110 provides for a scalable and programmable solution for allocating computing resources that automates the creation, monitoring, and the metering of a wide variety of computing environments.

In one embodiment, the UDC 110 is a provisional UDC. As such, the UDC 110 utilizes a programmable infrastructure that enables the virtual connection of any computing resource as well as the isolation of a set of computing resources, thereby ensuring the security and segregation of computing resources at the lowest infrastructure level. As such, the UDC 110 can create and manage a plurality of virtual farms, each of which utilize a set of computing resources in the UDC 110.

The operations center 120 provides for overall control over the UDC 110. In one embodiment, the operations center 120 is manned by network technicians that monitor the management and allocation of computing resources in the UDC 110. The network technicians also provide for the installation and repair of physical resources in the pool 150 of computing resources. The physical resources in the resource pool 150 can be coupled to the plurality of end users through the network 145. In addition, a firewall 170 can provide one form of additional security for the UDC 110 when communicating through the network 145.

The UDC 110 also comprises a network-based intrusion detection system (NIDS) 125. The NIDS 125 is coupled to the operations center 120 in one embodiment, and monitors network traffic (e.g., packets) to determine whether unauthorized traffic is flowing into the utility controller 130. The NIDS 125 comprises one or more sensors that monitor network traffic within the UDC 110. Each of the sensors reports traffic anomalies to a NIDS manager that determines noteworthy traffic events. The NIDS 125 looks for attack signatures (e.g., software viruses that attack operating system), or unusual events, such as, protocol anomalies or unusual traffic that may signify an attack on the network of the UDC 110. The NIDS determines whether suspicious traffic events are occurring in the network and notifies the IDS manager 135 in the utility controller 130 of those suspicious traffic events. The IDS manager 135 can then make the appropriate response.

The pool 150 of computing resources in the UDC 110 is comprised of a pre-wired, pre-integrated, and pre-tested plurality of physical resources that form a pool from which multiple farms can be created on demand. The computing resources include, but are not limited to, the following systems and devices, such as: servers, switches, computers, appliances (e.g., load balancers and firewalls), and network elements. The computing resources in the pool 150 are physically pre-wired (ideally a one-time wiring solution) and then dynamically, and logically re-wired into various virtual farm environments. The computing resources can be logically re-wired using virtual local area network technology (VLAN), in one embodiment.

Located within each of the computing resources in the pool 150 of computing resources are host-based intrusion detection system (HIDS) 155. For example, within a particular computing resource, the HIDS 155 comprises a HIDS manager and one or more HIDS sensors. The HIDS sensors focus on events happening within the computing resource. That is, the HIDS sensors monitor the actions of the computing resource to determine whether an unauthorized intrusion into the computing resource is occurring. The HIDS is configurable to each of the computing resources depending on the functions of the computing resources within the data center, and their particular vulnerability to attack. For example, the HIDS sensors may be monitoring password files to determine when there are unauthorized writings to the password files. Also, HIDS sensors may be monitoring system log files to determine when the system log file has been modified to remove a record. The HIDS sensors notify the HIDS manager located on the computing resource that an intrusion has occurred. Thereafter, the HIDS manager examines the intrusion detection and alerts the IDS manager 135 in the utility controller 130 when necessary.

In another embodiment, the UDC 110 supports multi-vendor and open system support for the plurality of computing resources in the pool 150. As such, the UDC 110 can provide support to computing resources in the pool 150 that have the same functionality (e.g., firewalls) but are provided by different vendors. Also, the UDC 110 can support the various operating systems that each of those computing resources may use.

The utility controller 130 enables the deployment, segmentation, and management of resources and farms. The farms deployed with computing resources from the pool 150 can be tailored to meet a wide variety of services. Each farm has its own dedicated computing and appliance resources. The farms can share common resources, such as storage and networking fabric.

The utility controller 130 manages the pool 150 of computing resources in the UDC 110. Specifically, the utility controller 130 ensures the segmentation of farms, thereby securely isolating one farm from other farms. Also, the utility controller 130 monitors all deployed farms, and automatically re-deploys replacement resources if there are any failures in computing resources detected. In addition, the utility controller 130 monitors shared infrastructure resources, alerting the operations center of failures or other significant events, such as, intrusion attempts.

The utility controller also contains the IDS manager 135, in one embodiment. The IDS manager is capable of responding to IDS alerts detected and generated from remote IDS sensors in the UDC 110. In this way, appropriate responses to the IDS alerts are separated from the infected computing resources in the UDC and the responses are unaffected by the unauthorized intrusion.

Although embodiments of the present invention disclose responding to IDS alerts in a data center, other embodiments are well suited to responding to IDS alerts in any data network or network of computing resources. In addition, other embodiments are well suited to the verification of the correctness of power cabling configuration of computing resources in a provisional data center. Still other embodiments are well suited to the verification of the configuration of interrelated computing resources, such as, the configuration of power cables to computing resources that are located on a rack that contains the interrelated computing resources.

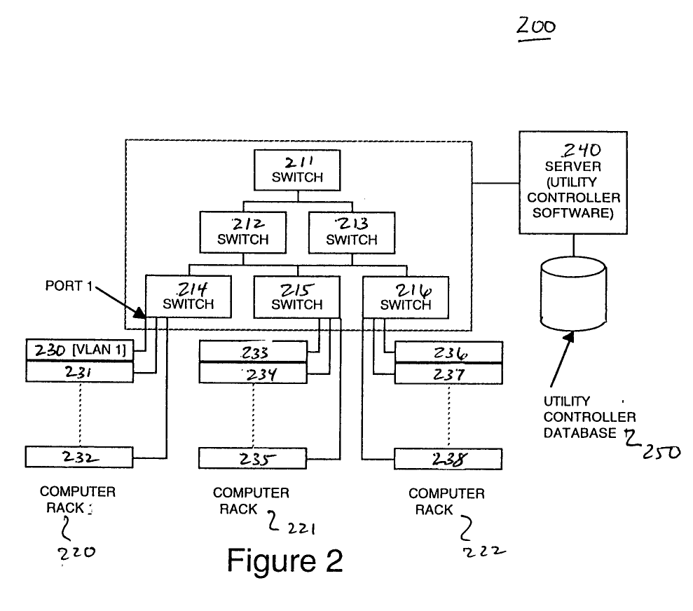

FIG. 2 is a block diagram of an exemplary local area network (LAN) 200 (which may reside in a provisional data center) upon which embodiments of the present invention can be implemented. It is appreciated that LAN 200 can include elements in addition to those shown (e.g., more racks, computers, switches and the like), and can also include other elements not shown or described herein. Furthermore, the blocks shown by FIG. 2 can be arranged differently than that illustrated, and can implement additional functions not described herein.

In general, LAN 200 utilizes a programmable infrastructure that enables the virtual connection of selected computing resources as well as the isolation of selected computing resources, thereby ensuring the security and segregation of computing resources at the lowest infrastructure level. The pool of computing resources in the LAN 200 includes pre-wired, pre-integrated, and pre-tested physical resources. The computing resources in the LAN 200 can be dynamically and logically reconfigured into various virtual local area networks (VLANs). A number of such VLANs can be created and managed by the utility controller software.

In the present embodiment, LAN 200 includes a number of switches 211 through 216, and a number of computing resources 230-238 that are coupled to the switches 211-216. In one embodiment, the switches 211-216 are Ethernet switches. Typically, the computing resources 230-238 are physically located in computer racks 220, 221 and 222, although this may not always be the case. In this embodiment, the switches and computer systems are interconnected using cables or the like. However, wireless connections between devices in LAN 200 are also contemplated.

In the present embodiment, the switches 211-216 can be programmed or configured such that LAN 200 is logically separated into a number of VLANs. The programming or configuring of these switches can be changed, thereby changing the resources allocated to the various VLANs. For example, by changing the configuration of switch 214, computer system 230 can be “moved” from one VLAN to another. The allocation and reallocation of resources between VLANs can be achieved without changing the physical wiring between devices.

In addition to computer systems and switches, LAN 200 can include other types of devices such as, but not limited to, routers, load balancers, firewalls, and hubs. These other types of devices may also be programmable or configurable. As will be seen, the features of the present invention can be used with these types of devices as well as with switches. That is, although described primarily in the context of switches, the features of the present invention are not so limited.

The term “configurable device” is used herein to refer to devices that can be programmed or configured. The term “configuration information” is used herein to refer to information that describes the configuration of a configurable device. If, for example, a configurable device is reallocated from one VLAN to another, its configuration information is updated to effect the change. In the present embodiment, the configuration information for a configurable device resides on the device, from which it can be read or retrieved. The actual configuration of a configurable device is also referred to herein as the “as-built” configuration of the device.

In the present embodiment, LAN 200 includes or is coupled to a server 240. Server 240 executes utility controller software for managing the resources in LAN 200, and as such server 240 can also be referred to as a utility controller. For example, the utility controller software executed by server 240 enables the deployment, allocation, and management of VLANs. The utility controller software monitors deployed VLANs, and automatically reallocates resources when there is a reason to do so.

In the present embodiment, server 240 includes a utility controller database 250; alternatively, utility controller database 250 can reside in a separate storage device that is coupled to the server 240. Utility controller database 250 includes information pertaining to the various resources in LAN 200. Importantly, utility controller database 250 includes information that is regarded as a correct and accurate representation of the LAN 200 as it is designed and as it should be implemented.

The utility controller database 250 is also referred to herein as “reference information,” “design information,” or “design basis information.” As resources in LAN 200 are reallocated, the information in utility controller database 250 is also changed. Changes to the utility controller database 250 can also be used to drive changes to the allocation of resources in LAN 200.

Utility controller database 250 includes information such as the types of devices in LAN 200 and a representation of each VLAN. Other information included in utility controller database 250 includes, but is not limited to: the network or MAC (media access control) address for the resources of LAN 200; the port numbers of the configurable devices; the VLAN identifiers associated with each of the port numbers; the socket identifier for each cable connected to each of the resources of LAN 200; manufacturer and model numbers; and serial numbers.

In one embodiment, utility controller database 250 is embodied as a computer-readable network map. It is understood that such a map need not exist in the form conventionally associated with human-readable maps. It is also appreciated that a computer-readable network map can be synthesized on-the-fly from the information stored in utility controller database 250.

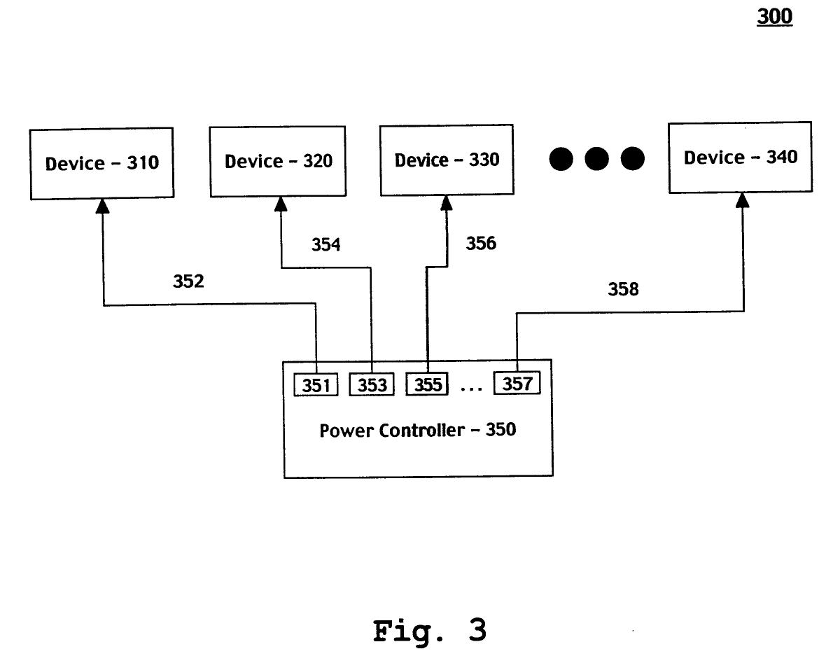

FIG. 3 is a block diagram illustrating cabling of the network 300 of computing resources. The network 300 includes a plurality of n computing resources, including device 310, device 320, device 330, on up to the n-th device, device 340. The computing resources include systems or devices, such as, network switches, routers, firewalls, load balancers, terminal servers, Storage Area Network (SAN) switches, and computers, etc, as previously described.

The network 300 also comprises a power controller 350 which provides power to the plurality of n computing resources. Power controller 350 comprises a plurality of power sources, as follows: power port 351, power port 353, power port 355, on up to the n-th power port 357. In another embodiment, redundant power controllers with redundant power sources provide redundant power to the plurality of n computing resources in the network 300.

Power controller 350 provides power to each of the plurality of n computing resources in the network 300. Alternatively, the plurality of n computing resources could consume power in a subset of the network 300 and comprise a rack of computing devices. More particularly, power controller 350 provides power to device 310 from power port 151 via cable 352. Power controller 350 also provides power to device 320 from power port 353 via cable 354. Power controller 350 also provides power to device 330 from power port 355 via cable 356. Power controller 350 also provides power to device 340 from power port 357 via cable 358.

Embodiments of the present invention are capable of shutting down power to each of the plurality of n computing resources in response to IDS alerts that indicate an unauthorized intrusion into one of the plurality of n computing resources. In that way, when an unauthorized intrusion is detected in a particular computing resource, power to the computing resource is shut down in order to minimize damage to the computing resource from the unauthorized intrusion. For example, when a HIDS on the particular computing resource has detected that a malicious worm is running on the computing resource and causing damage to the computing resource, embodiments of the present invention are capable of immediately and automatically stopping the flow of electrical power to the infected computing resource. In that way, damage to the infected computing system is stopped, possibly saving valuable information and/or reducing the required recovery time.

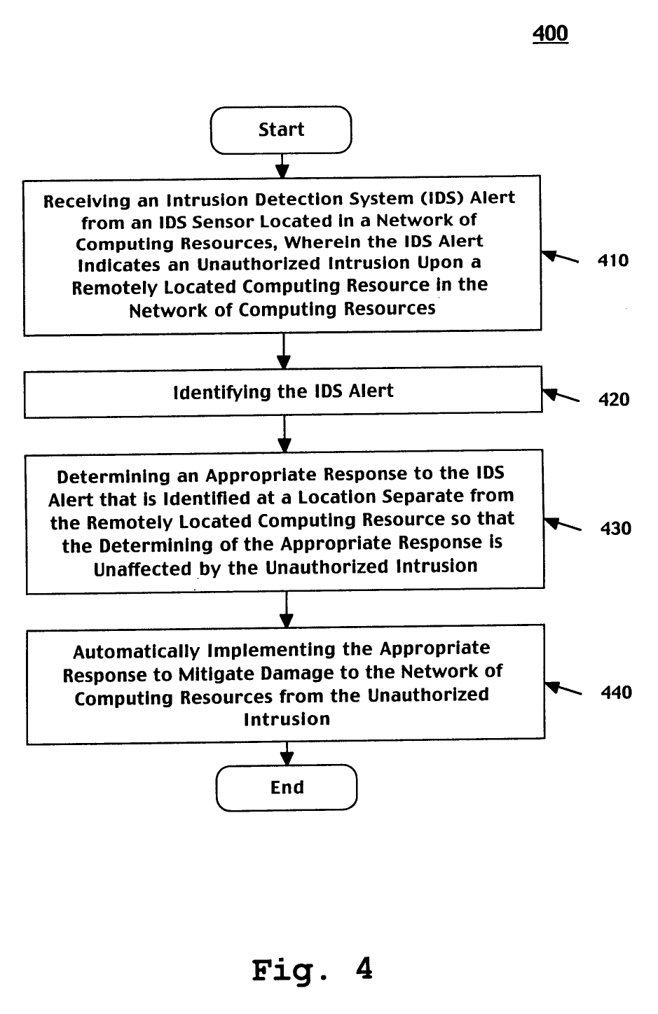

Referring now to FIG. 4, a flow chart 400 illustrating steps in a computer implemented method for responding to IDS alerts in a data center is disclosed, in accordance with one embodiment of the present invention. The method of flow chart 400 is implemented to mitigate damage to computing resources in the data center from unauthorized intrusions.

The present embodiment begins by receiving an IDS alert from an IDS sensor located in a network of computing resources, at 410. In one embodiment, the network of computing resources is a provisional data center. The IDS alert is from HIDS or NIDS sensors in a HIDS or NIDS system within the network of computing resources, in embodiments of the present invention. The IDS alert indicates an unauthorized intrusion upon a remotely located computing resource in the network of computing resources. That is, the unauthorized intrusion is occurring on a computing resource remotely located from the IDS manager.

The IDS alert is received at an IDS manager that monitors and/or provides control over the plurality of IDS sensors in the network of computing resources. The IDS manager may be located separate from the remotely located computing resource that is infected.

The present embodiment continues by identifying the IDS alert, at 420. By identifying the IDS alert, an appropriate response can be determined according to the identified IDS alert. By separating control of responding to the IDS alerts away from the infected computing resource in the network of computing resources, the appropriate response to the IDS alert can be implemented and performed. That is, the unauthorized intrusion is unable to deleteriously disable the proper response to the IDS alert associated with the unauthorized intrusion.

At 430, the present embodiment, determines an appropriate response to the IDS alert that is identified. The determination is made at a location separate from the remotely located computing resource that is infected by the unauthorized intrusion so that the determination of the appropriate response is unaffected by the unauthorized intrusion.

At 440, the present embodiment continues by implementing the appropriate response to mitigate damage to the network of computing resources from said unauthorized intrusion. In one embodiment, the appropriate response is to interface with a power controller that controls power to the infected computing resource in order to shut down power to said computing resource. By shutting down power to the computing resource further damage to the computing resource from the unauthorized intrusion (e.g., deletion of files) is prevented.

In another embodiment, the appropriate response is to interface with at least one switch in the network of computing resources to virtually reconfigure that switch in order to virtually isolate the computing resource from the remaining computing resources in the network of computing resources. In that way, the network of computing resources is protected from damage due to the unauthorized intrusion. In one embodiment, the switch comprises an Ethernet switch. In another embodiment, the switch comprises a SAN switch. In still another embodiment, the response may interface with both an Ethernet switch and a SAN switch.

For example, an unauthorized intrusion may be detected when a NIDS detects that an internet web server is performing port scans (a network fingerprinting technique used by malicious hackers) on the network of computing resources. This indicates that a hacker has gained unauthorized access to a computing resource, or an authorized administrator is performing unauthorized actions. The present embodiment is capable of being configured to automatically and immediately reconfigure the switches to disable the network switch ports to which the infected computing resource is attached. This prevents the attacker from having any further access to the infected computing resource, and prevents the attacker from using the infected computing resource to gain unauthorized access to other computing resources in the network of computing resources. In addition, any malicious (or other) software running on the infected computing resource is also prevented from contacting any other system.

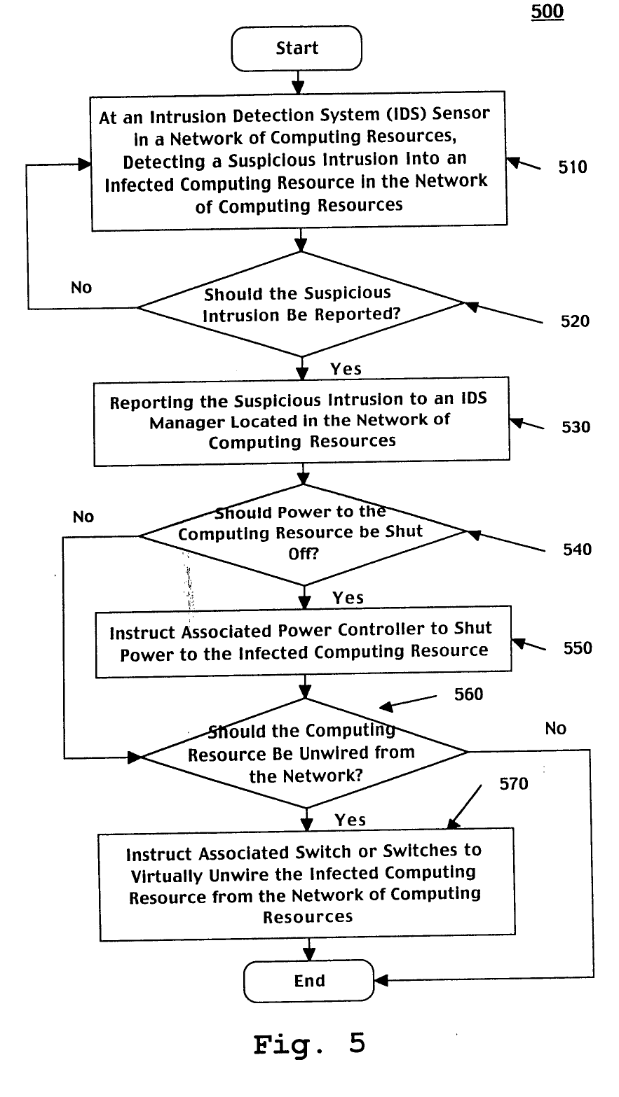

Referring now to FIG. 5, a flow chart 500 illustrating steps in a computer implemented method for determining IDS alerts and responding to the IDS alerts is disclosed, in accordance with one embodiment of the present invention. The method of flow chart 500 is implemented to mitigate damage to computing resources in the data center from unauthorized intrusions.

The present embodiment begins by detecting a suspicious intrusion into an infected computing resource in a network of computing resources (e.g., a provisional data center), at 510. The suspicious intrusion is detected at an IDS sensor that is located at a HIDS or NIDS system, according to embodiments of the present invention.

At decision step 520, the present embodiment determines whether the suspicious intrusion must be reported. As such, the present embodiment must determine whether the suspicious intrusion is unauthorized. In one embodiment, the suspicious intrusion is compared to a list of unauthorized intrusions.

If the suspicious intrusion does not match an intrusion on the list of unauthorized intrusions, then the suspicious intrusion is not an unauthorized intrusion. As such, the present embodiment returns back to 510.

On the other hand, if the suspicious intrusion matches an intrusion on the list of unauthorized intrusions, then the suspicious intrusion is an unauthorized intrusion. Then, the present embodiment, generates the IDS alert, and reports the IDS alert to an IDS manager that is located remotely to the infected computing resource in the network of computing resources, at 530.

As such, the present embodiment is capable of interfacing with the various IDS systems (e.g., HIDS and NIDS) in place in the network of computing resources. Responses to the IDS alerts generated by the various IDS systems are removed from the infected computing resources, in order to better ensure an appropriate response to the IDS alert is not affected or disabled by the unauthorized intrusion into the infected computing resource.

At decision step 540, the present embodiment determines whether power to the computing resource should be shut off. That is, the IDS alert is identified. After identification, the present embodiment is capable of determining whether power to the infected computing resource should be shut off depending upon the identified IDS alert.

If power should be shut off to the infected computing resource, then the present embodiment instructs the associated power controller to shut off power to the infected computing resource, at 550. In that way, as previously discussed, further damage to the infected computing resource is prevented. Thereafter, the present embodiment continues to 560.

On the other hand, if power should not be shut off to the infected computing resource, then the present embodiment continues to 560 to determine whether the computing resource should be isolated from the remaining computing resources in the network of computing resources. That is, the present embodiment determines whether the infected computing resource should be logically unwired from the network of computing resources.

If the present embodiment determines that the infected computing resource should not be unwired from the network, then the present embodiment of flow chart 500 ends.

On the other hand, if the present embodiment determines that the infected computing resource should be unwired from the network, then an instruction is sent to the associated switch or switches to virtually unwire the infected computing resource from the network of computing resources. In that way, the infected computing resource is isolated from the remaining computing resources in the network of computing resources in order to prevent and mitigate damage to the remaining computing resources from the unauthorized intrusion. Thereafter, the present embodiment of flow chart 500 ends.

In other embodiments, the methods as described in flow charts 400 and 500 are performed automatically. In that case, the responses to IDS alerts are determined and performed automatically according to the identified IDS alerts.

Accordingly, embodiments of the present invention provide a method and system for responding to IDS alerts in a data center. As a result, other embodiments of the present invention serve the above purpose and provide for automatic responses to IDS alerts, resulting in a reduction in damage to the data center from intrusion due to reduced response times. Also, other embodiments of the present invention serve the above purposes and provide for the elimination of human intervention when responding to an IDS alert, thereby decreasing the response time and reducing the resulting damage to the data center from unauthorized intrusion. Additionally, other embodiments of the present invention serve the above purposes and provide for the removal of the software responsible for responding to IDS alerts to a location separate from the computing resource upon which the intrusion is detected. As a result, a separate system for responding to the IDS alerts that has not been compromised through the intrusion is capable of responding appropriately to the intrusion as detected from the IDS alerts.

While the methods of embodiments illustrated in flow charts 400 and 500 show specific sequences and quantity of steps, the present invention is suitable to alternative embodiments. For example, not all the steps provided for in the methods are required for the present invention. Furthermore, additional steps can be added to the steps presented in the present embodiment. Likewise, the sequences of steps can be modified depending upon the application.

A method and system for responding to IDS alerts in a provisional data center is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

1. A method for responding to network intrusions, comprising:
a) receiving an intrusion detection system (IDS) alert from an IDS sensor located in a network of computing resources, wherein said IDS alert indicates an unauthorized intrusion upon a remotely located computing resource in said network of computing resources;
b) identifying said IDS alert; and
c) determining an appropriate response to said IDS alert that is identified at a location separate from said remotely located computing resource so that said determining said appropriate response is unaffected by said unauthorized intrusion; and
d) automatically implementing said appropriate response to mitigate damage to said network of computing resources from said unauthorized intrusion.

2. The method of claim 1, wherein a) further comprises:
a1) detecting a suspicious intrusion into said computing resource;
a2) determining said suspicious intrusion is unauthorized;
a3) generating said IDS alert; and
a4) sending said IDS alert to an IDS manager that is located remotely from said computing resource within said network of computing resources.

3. The method of claim 2, wherein a2) further comprises:
determining said suspicious intrusion is unauthorized when said suspicious intrusion matches with at least one of a list of unauthorized intrusions.

4. The method of claim 2, wherein a1) comprises:
detecting said suspicious intrusion at a host-based intrusion detection system (HIDS) sensor located on said computing resource.

5. The method of claim 2, wherein a1) comprises:
detecting said suspicious intrusion at a network-based intrusion detection system (NIDS) sensor located within said network of computing resources.

6. The method of claim 1, wherein d) further comprises:
d1) interfacing with a power controller that controls power to said computing resource to shut power to said computing resource.

7. The method of claim 1, wherein d) further comprises:
d1) interfacing with at least one switch, an associated switch, in said network of computing resources to virtually reconfigure said associated switch in order to virtually isolate said computing resource from remaining computing resources in said network of computing resources.

8. The method of claim 7, wherein said associated switch comprises an Ethernet switch.

9. The method of claim 7, wherein said associated switch comprises a Storage Area Network (SAN) switch.

10. The method of claim 7, wherein said at least one switch comprises a SAN switch and an Ethernet switch.

11. The method of claim 1, wherein said network of computing resources comprises a provisional data center.

12. A method for responding to network intrusions, comprising:
a) receiving an intrusion detection system (IDS) alert from an IDS sensor in a network of computing resources at a location separate from an infected computing resource, wherein said IDS alert indicates an unauthorized intrusion upon said infected computing resource in said network of computing resources, wherein implementation of a response to said IDS alert is unaffected by said unauthorized intrusion;
b) responding to said IDS alert by automatically interfacing with at least one switch in said network of computing resources to virtually reconfigure said at least one switch, an associated switch, in order to virtually isolate said computing resource from remaining computing resources in said network of computing resources; and
c) responding to said IDS alert by automatically interfacing with a power controller that controls power to said computing resource to shut power to said computing resource.

13. The method of claim 12, wherein a) further comprises:
a1) detecting a suspicious intrusion into said computing resource;
a2) determining said suspicious intrusion is unauthorized;
a3) generating said IDS alert; and
a4) sending said IDS alert to an IDS manager that is located remotely from said computing resource within said network of computing resources.

14. The method of claim 13, wherein a2) further comprises:
determining said suspicious intrusion is unauthorized when said suspicious intrusion matches with at least one of a list of unauthorized intrusions.

15. The method of claim 13, wherein a1) comprises:
detecting said suspicious intrusion at a host-based intrusion detection system (HIDS) sensor located on said computing resource.

16. The method of claim 13, wherein a1) comprises:
detecting said suspicious intrusion at a network-based intrusion detection system (NIDS) sensor located within said network of computing resources.

17. The method of claim 12, wherein said network of computing resources comprises a provisional data center.

18. The method of claim 12, wherein said switch couples said computing resource to a virtual local area network.

19. The method of claim 12, wherein said switch comprises an Ethernet switch.

20. The method of claim 12, wherein said associated switch comprises a Storage Area Network (SAN) switch.

21. The method of claim 12, wherein said at least one switch comprises a SAN switch and an Ethernet switch.

22. The method of claim 12, wherein further comprising:
automatically interfacing with said associated switch in said network of computing resources; and
automatically interfacing with said power controller.

23. A computer system comprising:
a bus for communicating information associated with a method for responding to network intrusions;
a processor coupled to said bus for processing said information associated with said method for responding to network intrusions; and
a computer readable memory coupled to said processor containing program instructions, that when executed by said processor, implement said method for responding to network intrusions, comprising:
a) receiving an intrusion detection system (IDS) alert from an IDS sensor located in a network of computing resources, wherein said IDS alert indicates an unauthorized intrusion upon a remotely located computing resource in said network of computing resources;
b) identifying said IDS alert; and
c) determining an appropriate response to said IDS alert that is identified at a location separate from said remotely located computing resource so that said determining said appropriate response is unaffected by said unauthorized intrusion; and
d) automatically implementing said appropriate response to mitigate damage to said network of computing resources from said unauthorized intrusion.

24. The computer system of claim 23, wherein a) in said method further comprises:
a1) detecting a suspicious intrusion into said computing resource;
a2) determining said suspicious intrusion is unauthorized;
a3) generating said IDS alert; and
a4) sending said IDS alert to an IDS manager that is located remotely from said computing resource within said network of computing resources.

25. The computer system of claim 24, wherein a2) in said method further comprises:
determining said suspicious intrusion is unauthorized when said suspicious intrusion matches with at least one of a list of unauthorized intrusions.

26. The computer system of claim 24, wherein a1) in said method comprises:
detecting said suspicious intrusion at a host-based intrusion detection system (HIDS) sensor located on said computing resource.

27. The computer system of claim 24, wherein a1) in said method comprises:
detecting said suspicious intrusion at a network-based intrusion detection system (NIDS) sensor located within said network of computing resources.

28. The computer system of claim 23, wherein d) in said method further comprises:
d1) interfacing with a power controller that controls power to said computing resource to shut power to said computing resource.

29. The computer system of claim 23, wherein d) in said method further comprises:
d1) interfacing with at least one switch, an associated switch, in said network of computing resources to virtually reconfigure said associated switch in order to virtually isolate said computing resource from remaining computing resources in said network of computing resources.

30. The computer system of claim 29, wherein said associated switch comprises an Ethernet switch.

31. The computer system of claim 29, wherein said associated switch comprises a Storage Area Network (SAN) switch.

32. The computer system of claim 29, wherein said at least one switch comprises a SAN switch and an Ethernet switch.

33. The computer system of claim 23, wherein said network of computing resources comprises a provisional data center.
